(19) United States
(12) Patent Application Publication
(10) Pub. No.: US 2016/0126829 A1
(43) Pub. Date: May 5, 2016

(54) INDUCTOR AND POWER FACTOR CORRECTOR USING THE SAME

(71) Applicant: Chicony Power Technology Co., Ltd., New Taipei City (TW)

(72) Inventors: Tzu-Hung WANG, New Taipei City (TW); Hao-Te HSU, New Taipei City (TW); Shih-Hung LO, New Taipei City (TW)

(21) Appl. No.: 14/533,096

(22) Filed: Nov. 5, 2014

(51) Int. Cl. H02M 1/42; H01F 3/14

(52) U.S. Cl. CPC H02M 1/4208; H01F 3/14

(57) ABSTRACT

The present invention is related to an inductor, which includes winding set, a magnetic core, and an auxiliary magnetic core. The magnetic core includes a winding part and two opposite end-surfaces. The auxiliary magnetic core including a top surface is attached on one of the end surface and faces the other end surface so as to form an air gap therebetween. The permeability of the auxiliary magnetic core is smaller than that of the magnetic core. The winding is wound around the winding part, the air gap, and the auxiliary magnetic core. The auxiliary magnetic core achieves magnetic saturation before that of the magnetic core when current flowing through the winding set is increased, which reduces current variation per unit time of the inductor.

### BACKGROUND OF THE INVENTION

1. Field of the Invention

The present invention relates to a power factor corrector and an inductor applied to the power factor corrector, and in particular to a power factor corrector with high-efficiency when operated between typical load and light load, and an inductor having different inductances when operated under typical load and light load.

2. Description of Related Art

In alternative current (AC) circuitry, power factor is defined by the ratio of the real power and apparent power. Power factor corrector is used for shifting wave shape and phase between the voltage and current of the received input power to reduce or minimize the phase difference between them at the output of the power factor corrector.

In the power factor corrector, inductor is used for storing energy to shift wave shape and phase between the voltage and current of the received input power. Currently, the inductor adapted in the power factor corrector includes two magnetic core and a large air gap located therebetween to prevent magnetic flux density from saturation in a short time under typical load operation. However, large air gap increases magnetic resistance when the power factor is operated under light load, thus reducing operation efficiency.

### SUMMARY OF THE INVENTION

It is an object of the present invention to provide an inductor to overcome above-mentioned problem

Accordingly, the present invention provides an inductor comprising magnetic core, an auxiliary magnetic core, and a winding set. The magnetic core comprises a winding part and two opposite end surfaces. The auxiliary magnetic core comprises a top surface. The auxiliary magnetic core is attached on one of the end surfaces and spaced from the other end surface to form an air gap. The permeability of the auxiliary magnetic core is smaller than that of the magnetic core. The winding set is wound on the winding part, the air gap, and the auxiliary magnetic core. The auxiliary magnetic core achieves magnetic saturation before that of the magnetic core when a current flowing through the winding set is increased to reduce current variation per unit time of the inductor.

In an embodiment of the present invention, the magnetic core comprises a first magnetic core and a second magnetic core. The first magnetic core comprises a first central leg, two first outer legs arranged at two opposite sides of the first central leg, and two first accommodating recesses located between the first central leg and the first outer legs, the first central core comprising an end surface. The second magnetic core comprises a first central leg, two second outer legs arranged at two opposite sides of the first central leg, and two second accommodating recesses located between the first central leg and the second outer legs. The auxiliary magnetic core comprises a top surface. The first outer legs is connected to the second outer legs, the end surface of the first central core faces and is spaced from the top surface of the auxiliary magnetic core, and an air gap formed between the top surface and the end surface. The winding set is wound on the first central core, the air gap, the auxiliary magnetic core, and the second central core. The magnetic flux density of the first central core and the second central core are respectively higher than that of the auxiliary magnetic core when the current flowing through the winding set.

In an embodiment of the present invention, the magnetic core is an annular magnet.

It is an object of the present invention to provide a power factor corrector. The power factor corrector is electrically connected to an AC to DC power convertor and a load. The power factor corrector comprises the inductor 1, mentioned above, a diode D, a switch S, and a capacitor C. The inductor is electrically connected to the AC to DC power convertor, the diode is electrically connected to the inductor and the load, the switch is electrically connected to the capacitor and the diode, and the capacitor is electrically connected to the diode and the switch. The power factor corrector controls operations of the switch to control current flowing through the inductor, and shift wave shape and phase between the voltage and current of the received input power to reduce or minimize the phase difference between them at the output of the power factor corrector.

The inductor of the present invention uses the auxiliary magnetic core attached on the second central core modulates its inductances to adapt to different currents.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective view of a first magnetic core, a second magnetic core, and an auxiliary magnetic core according to a first embodiment of the present invention;

FIG. 2 is a sectional view of assembled first magnetic core, second magnetic core, and auxiliary magnetic core according to the first embodiment of the invention;

FIG. 3 is a sectional view of an inductor according to the first embodiment of the present invention;

FIG. 4 is a circuit diagram of a typical power factor corrector according to the preset invention;

FIG. 5 is a graph for showing a DC biased current dependence of inductance of inductors required in a power factor corrector;

FIG. 6 is a graph illustrating the relationship between load and efficiency in a typical power factor corrector; and

FIG. 7 is top view of an inductor according to a second embodiment of the present invention.

### DETAILED DESCRIPTION OF THE INVENTION

A preferred embodiment of the present invention will be described with reference to the drawings.

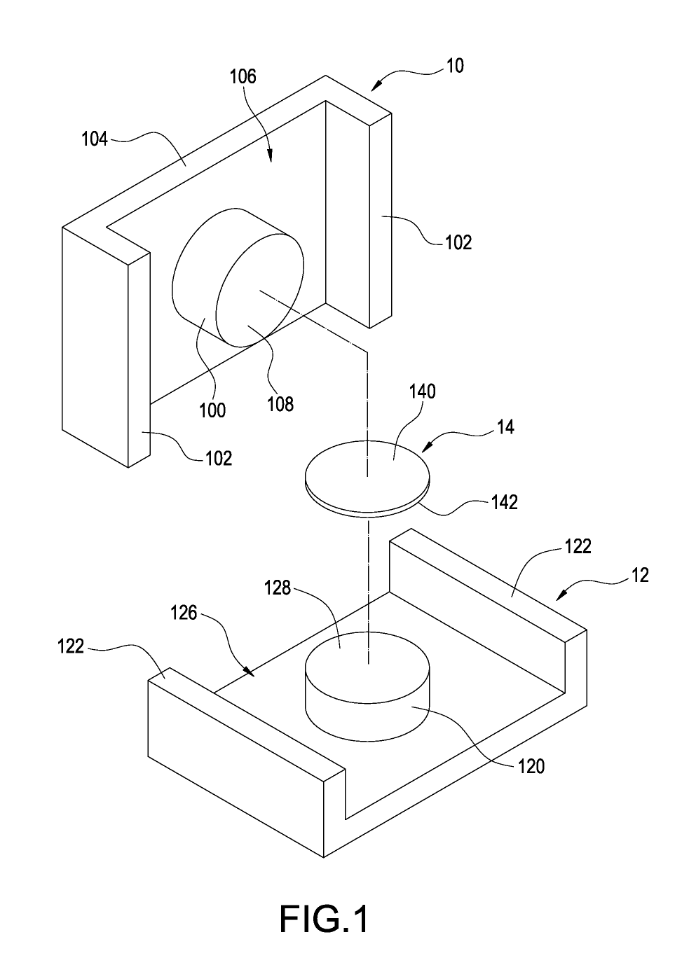

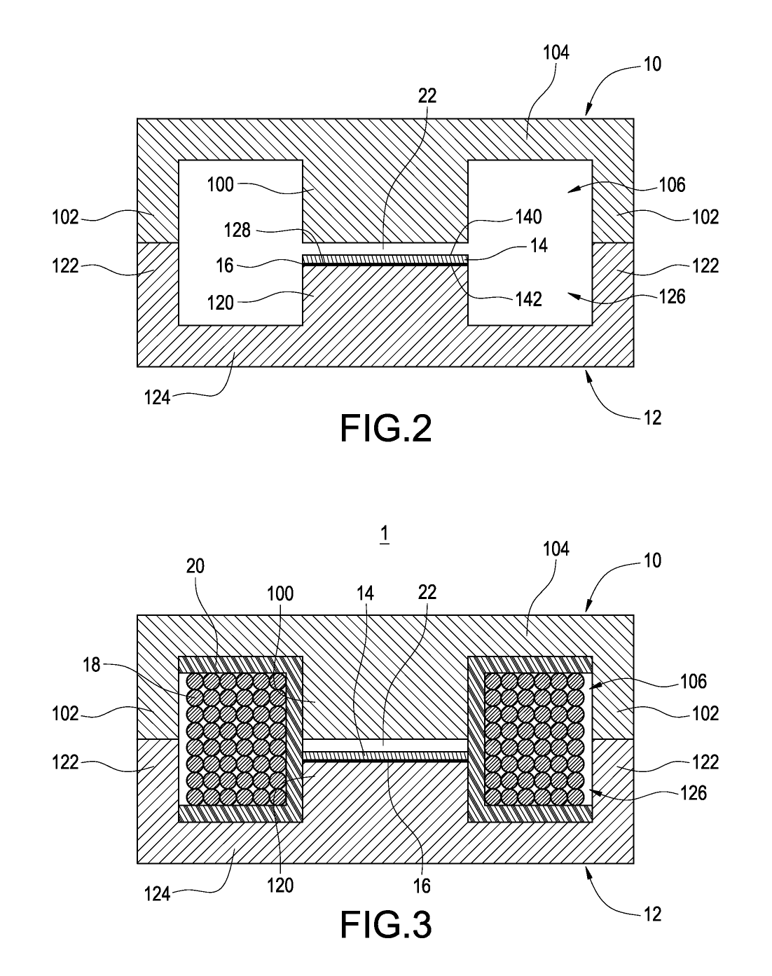

Reference is made to FIG. 1 and FIG. 2, which are respectively a perspective view and assembled view of a first magnetic core, a second magnetic core, and an auxiliary core according to a first embodiment of the present invention. An inductor 1 of the present invention includes a first magnetic core 10, a second magnetic core 12, and an auxiliary magnetic core 14.

The first magnetic core 10 includes a first central leg 100, two first outer legs 102 arranged at two opposite sides of the first central leg 100, and a first base 104 connected to the first central leg 100 and the first outer legs 102. The first magnetic core 10 further includes first recesses 106 collectively defining by the first central leg 100, the first outer legs 102, and the first base 104, so that the first magnetic core 10 is substantially of E-shape. The first central leg 100, the first outer legs 102, and the first base 104 are respectively made of magnetic material, and the first central leg 100, the first outer legs 102, and the first base 104 are one-piece formed.

In this embodiment, the first central leg 100 is substantially a cylinder, so that an end surface 108 formed on the first central leg 100 and far away from the first base 104 is circular and substantially a plane.

The second magnetic core 12 includes a second central leg 120, two second outer legs 122 arranged at two opposite sides of the second central leg 120, and a second base 124 connected to the second central leg 120 and the second outer legs 122. The second magnetic core 12 further includes second recesses 126 collectively defining by the second central leg 120, the second outer legs 122, and the second base 124, so that the second magnetic core 12 is substantially of E-shaped. The second central leg 120, the second outer legs 122, and the second base 124 are respectively made of magnetic material, and the second central leg 100, the second outer legs 102, and the second base 104 are one-pieced formed. It should be note that the first magnetic core 10 and the second magnetic core 12 are made of the same material, the first magnetic core 10 and the second magnetic core 12 may be individually formed or one-piece form.

The profile of the second central leg 120 is substantially a cylinder, and an end surface 128 arranged on one side of the second magnetic core 120 and far away from the second base 120. The end surface 128 is circular and substantially a plane.

The profile of the auxiliary magnetic core 14 is cylinder and has a circular top surface 140 and a circular bottom surface 142. The top surface 140 and the bottom surface 142 are planes. The surface area of the bottom surface 142 is the same as that of the end surface 128, and the surface area of the top surface 140 is the same as that of the end surface 128. The auxiliary magnetic core 14 is, for example, made of ferrite material. The permeability of the first magnetic core 10 is larger than that of the auxiliary magnetic core 14, and the permeability of the second magnetic core 12 is larger than that of the auxiliary magnetic core 14.

The auxiliary core 14 is attached to the second central leg 142, and the bottom surface 142 of the auxiliary magnetic core 14 is attached to the end surface 128 of the second central leg 120. The inductor 1 may further include a resin 16 arranged between the second central leg 120 and the auxiliary magnetic core 14 for combining the auxiliary magnetic core 14 and the second central leg 120.

The first outer legs 102 of the first magnetic core 10 are respectively connected to the second outer legs 122 of the second magnetic core 12, the end surface 108 of the first central leg 100 faces the top surface 140 of the auxiliary magnetic core 14 and is spaced from the top surface 140 because there is an air gap 22 formed between the end surface 108 and the top surface 140. The air gap 22 is a linear air gap since the end surface 10 of the first central leg 100 and the top surface 140 of the auxiliary magnetic 14 are respectively planes.

The inductor 1 further includes a winding set 18, as shown in FIG. 3. The winding set 18 is wound on a winding part collectively defining by the first central leg 100, the second central leg 102, the auxiliary magnetic core 14, and the air gap 22. The inductor 1 may further include a bobbin 20 assembled with the winding part, and the winding set 18 is wound on the bobbin 20.

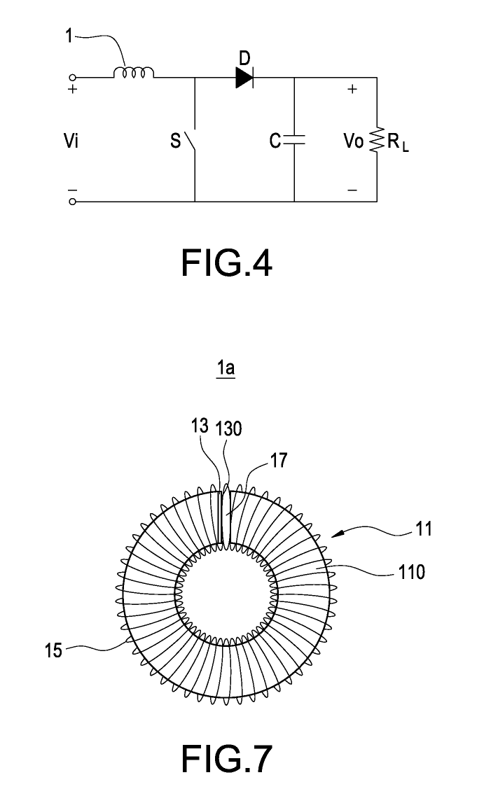

The inductor 1, a diode D, a switch S, and a capacitor C may constitute a power factor corrector, as shown in FIG. 4. The power factor corrector controls operations of the switch S to control current flowing through the inductor 1, and shift wave shape and phase between the voltage and current of the received input power to reduce or minimize the phase difference between them at the output of the power factor corrector. The power factor corrector includes an inputting terminal Vi and an outputting terminal Vo. The inputting terminal Vi is electrically connected to an alternative current (AC) to direct current (DC) power convertor and receives rectified sinusoidal-pulsing DC signal. The AC to DC converter is, for example, a bridge rectifier. The outputting terminal Vo is electrically connected to a load for receiving signal outputted from the power factor corrector. The power factor corrector has functions of stabling and increasing inputting voltage.

The inductor 1 is electrically connected to inputting terminal Vi and an anode of the diode D. the switch S is electrically connected to the inductor 1, the anode of diode D, and the inputting terminal Vi. The capacitor C is electrically connected to the outputting terminal Vo in parallel, and the cathode of the diode D. The switch S is, for example, a metal-oxide-semiconductor field effect-transistor (MOSFET).

The inductor 1 is charged since the switch S turns-on, and a loop is formed among the AC to DC power converter, the inductor 1, and the switch S. The inductor 1 is discharged by the diode D since the switch S turns-off, and at the mean while, the capacitor C is charged. The diode D can prevent inversing current flows through the inductor 1 when the switch S turns-off.

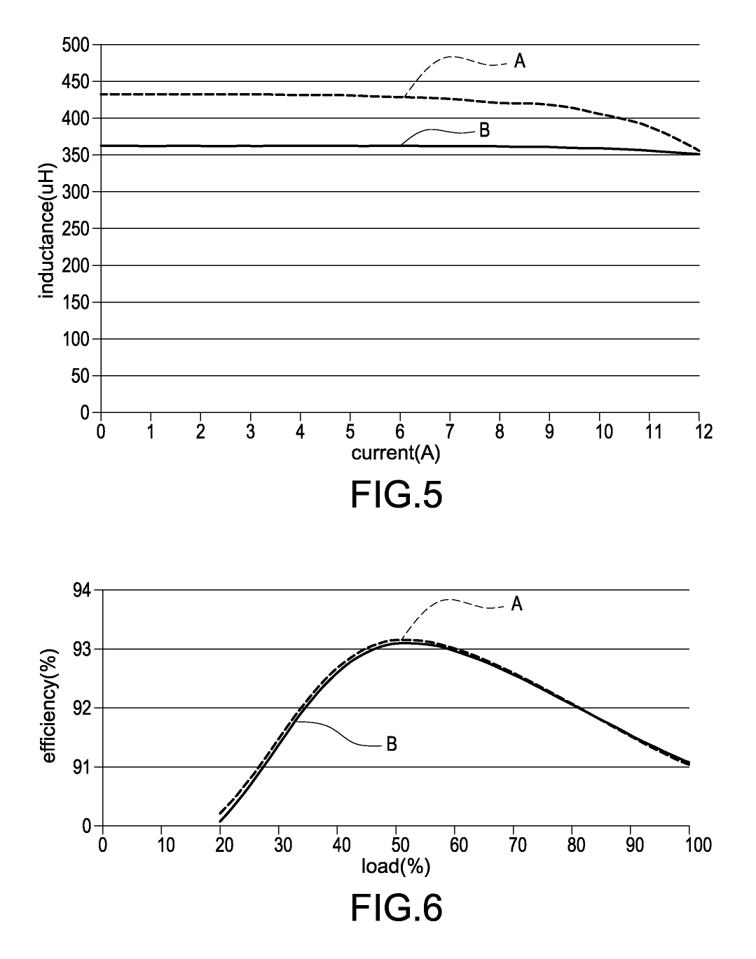

FIG. 5 is a graph for showing a DC biased current dependence of inductance of inductors required in a power factor corrector. The inductor 1 has a primary inductance when the power factor corrector is operated under light load (operating current lower than 6 amperes), and the power factor corrector is operated under typical load when the current conducting to the power factor corrector is increased and between 6 to 12 amperes. The magnetic flux density of the auxiliary magnetic core 14 is increased while the current increased, and then the auxiliary magnetic core 14 achieves magnetic saturation when the current is larger than a predetermined value. Since the permeability of the auxiliary magnetic core 14 is smaller than that of the first magnetic core 10 and the second magnetic core 12, the auxiliary magnetic core 14 achieves magnetic saturation earlier than that of the first magnetic core 10 and the second magnetic core 12.

Besides, the inductance of the inductor 1 is the product of voltages cross the inductor and the current variation per unit time, which means L=V·(dI/dt). When the auxiliary magnetic core 14 achieves magnetic saturation, the air gap 22 of the inductance 1 is then considered increasing since the magnetic resistance of the auxiliary magnetic core 14 is increased. Thus, the current variation per unit time of the inductor 1 decreases, and then the inductance of the inductor 1 decreases.

In short, the inductor 1 of the present invention has higher inductance under light load operation and lower inductance under typical load operation, so as to shift wave shape and phase between the voltage and current of the received input power to reduce or minimize the phase difference between them at the output of the power factor corrector, and then achieves better operative efficiency.

The curve B in FIG. 5 shows a conventional DC biased current dependence of inductance of inductors required in a power factor corrector. It is seen that the inductance of the conventional inductor is almost a constant whether it is operated under low current conduction (light load) or high current condition (typical load). Thus, when the conventional inductor is applied to a power factor corrector, the power factor corrector will have poor light load efficiency.

FIG. 6 is a graph illustrating the relationship between load and efficiency in a typical power factor corrector. In FIG. 6, curve C shows the relationship between load and efficiency of power factor corrector of present invention, and curve D shows the relationship between load and efficiency of the conventional power factor corrector. It is seen that the efficiency of the present invention is higher than that of the conventional when the load is lower than 50%.

In sum, the inductor 1 of the present invention uses the auxiliary magnetic core 14 attached on the second central core 120 modulates its inductances to adapt to different currents.

FIG. 7 is a top view of an inductor according to a second embodiment of the present invention. The inductor 1a includes a magnetic core 11, auxiliary magnetic core 13, and winding set 15. The magnetic core 11 includes a winding part 110 and two opposite end surfaces 112. In this embodiment, the magnetic core 11 is an annular magnet, and the end surfaces 112 are plane.

The permeability of the auxiliary magnetic core 13 is smaller than that of the magnetic core 11, so that the auxiliary magnetic core 13 achieves magnetic saturation earlier than that of the magnetic core 11. The auxiliary magnetic core 13 includes a top surface 130, which is substantially a plane. One of the end surfaces 112 of the auxiliary magnetic core 13 faces and is spaced from the other end surface 112, and an air gap 17 is formed therebetween. The air gap 17 is a linear air gap. The winding set 15 is wound on the winding part 110, the air gap 17, and the auxiliary magnetic core 13.

The inductor 1a, a diode, a switch, and a capacitor can collectively construct a power factor corrector shown in FIG. 4, and the function is the same as mentioned in the first embodiment.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An inductor comprising:
a magnetic core comprising a winding part and two opposite end surfaces;
an auxiliary magnetic core comprising a top surface, the auxiliary magnetic core attached on one of the end surfaces and spaced from the other end surface to form an air gap, the permeability of the auxiliary magnetic core being smaller than that of the magnetic core; and
a winding set wound on the winding part, the air gap, and the auxiliary magnetic core,
wherein the auxiliary magnetic core achieves magnetic saturation before that of the magnetic core when a current flowing through the winding set is increased to reduces current variation per unit time of the inductor.

2. The inductor in claim 1, wherein the magnetic core comprising:
a first magnetic core comprising a first central leg, two first outer legs arranged at two opposite sides of the first central leg, and two first accommodating recesses located between the first central leg and the first outer legs, the first central core comprising an end surface; and
a second magnetic core comprising first central leg, two second outer legs arranged at two opposite sides of the first central leg, and two second accommodating recesses located between the first central leg and the second outer legs, the auxiliary magnetic core comprising a top surface, the first outer legs connected to the second outer legs, the end surface of the first central core facing and spaced from the top surface of the auxiliary magnetic core, and an air gap formed between the top surface and the end surface, the winding set wound on the first central core, the air gap, the auxiliary magnetic core, and the second central core, wherein the magnetic flux density of the first central core and the second central core are respectively higher than that of the auxiliary magnetic core when the current flowing through the winding set.

3. The inductor in claim 1, wherein the magnetic core is an annual magnet.

4. The inductor in claim 1, wherein a surface area of the end surface is the same of that of the bottom surface.

5. A power factor corrector electrically connected to a load and an alternative current (AC) to direct current (DC) power converter for outputting DC electricity comprising:
an inductor electrically connected to the AC to DC power converter, the inductor comprising:
a magnetic core comprising a winding part and two opposite end surfaces;
an auxiliary magnetic core comprising a top surface, the auxiliary magnetic core attached on one of the end surfaces and spaced from the other end surface to form an air gap, the permeability of the auxiliary magnetic core being smaller than that of the magnetic core; and
a winding set wound on the winding part, the air gap, and the auxiliary magnetic core, wherein the auxiliary magnetic core achieves magnetic saturation before that of the magnetic core when a current flowing through the winding set is increased to reduces current variation per unit time of the inductor;
a diode electrically connected to the inductor and the load;
a switch electrically connected to the inductor and the diode; and
a capacitor electrically connected to the diode and the switch.

6. The power factor corrector in claim 5, wherein the a first magnetic core comprising a first central leg, two first outer legs arranged at two opposite sides of the first central leg, and two first accommodating recesses located between the first central leg and the first outer legs, the first central core comprising an end surface;
a second magnetic core comprising first central leg, two second outer legs arranged at two opposite sides of the first central leg, and two second accommodating recesses located between the first central leg and the second outer legs, the auxiliary magnetic core comprising a top surface, the first outer legs connected to the second outer legs, the end surface of the first central core facing and spaced from the top surface of the auxiliary magnetic core, and an air gap formed between the top surface and the end surface, the winding set wound on the first central core, the air gap, the auxiliary magnetic core, and the second central core, wherein the magnetic flux density of the first central core and the second central core are respectively higher than that of the auxiliary magnetic core when the current flowing through the winding set.

7. The power factor corrector in claim 5, wherein the magnetic core is an annular magnet.

8. The power factor corrector in claim 5, wherein the surface area of the end surface is the same as that of the top surface.
